(19) United States
(12) Patent Application Publication
(10) Pub. No.: US 2026/0089250 A1
(43) Pub. Date: Mar. 26, 2026

(54) MANAGING APPLICATION NOTIFICATIONS AND SYSTEM DIALOGS ON A FOLDABLE ELECTRONIC DEVICE IN A LAPTOP OR FLEX MODE

(71) Applicant: Lenovo (Beijing) Limited, Beijing (CN)

(72) Inventors: AMIT KUMAR AGRAWAL, Bangalore (IN); SRINIVASAN ARTHANARI, Bangalore (IN); T GOKULARAMANAN THIRUPPATHI, Salem Tamil Nadu (IN); XIAOFENG ZHU, Jiangsu (CN)

(21) Appl. No.: 18/907,366

(22) Filed: Oct. 4, 2024

Related U.S. Application Data
(63) Continuation of application No. PCT/CN2024/120398, filed on Sep. 23, 2024.

(51) Int. Cl. H04M 1/7243; G06F 1/16

(52) U.S. Cl. CPC H04M 1/7243; G06F 1/1641; G06F 1/1647; G06F 1/1686

(57) ABSTRACT

An electronic device, a method, and a computer program product manage application notifications and system dialogs while a foldable device is in a laptop/flex mode. The electronic device has a foldable form factor that enables desktop placement in a partially unfolded position for handsfree viewing. The electronic device presents a first logical display portion on a first display portion of the folding display and a second logical display portion on a second display portion of the folding display. In response to a first housing portion being in an angled position (i.e., partially unfolded) relative to a second housing portion, the electronic device modifies a selected one of the first logical display portion or the second logical display portion to present at least one notification or dialog on the selected one of the first logical display portion or the second logical display portion with which the user is actively interfacing.

### PRIORITY APPLICATION

This application claims priority to and is a continuation application of International Application No. PCT/CN2024/120398, filed Sep. 23, 2024, the content of which is fully incorporated herein by reference.

### BACKGROUND

### 1. Technical Field

The present disclosure relates generally to mobile electronic devices having a display, and more particularly to foldable mobile electronic devices having display(s) incorporated on each inner side of a foldable housing.

### 2. Description of the Related Art

As technology has advanced, uses for electronic devices have expanded. One such use is small mobile devices, such as smartphones, which have become increasingly powerful despite their small size. For additional portability, some mobile devices have a foldable housing. These mobile devices provide a great deal of portable processing power, but the small size for portability limits display size and on-device input controls. Various notifications and system dialogs (e.g., lockscreen, application notifications, volume slider, status bar, etc.) are defined for the mobile device display when the foldable housing is in a fully unfolded open position (i.e., a straightened flat mode), in which the notifications and dialogs are clearly viewable and accessible for the user. However, when the mobile device is placed in a laptop mode or flex mode, in which the foldable housing is placed in a partially unfolded angled position, corresponding means for presenting and accessing the application notifications and system dialogs are not defined currently.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 presents a simplified functional block diagram of a foldable electronic device in which the features of the present disclosure are advantageously implemented for managing the presentation of notifications and dialogs on the foldable electronic device, according to one or more embodiments;

FIG. 2A illustrates a front view of the electronic device having a foldable housing in a fully unfolded open position, according to one or more embodiments;

FIG. 2B illustrates a back view of the electronic device having a foldable housing in a fully unfolded open position, according to one or more embodiments;

FIG. 3A illustrates a perspective view of the electronic device having a foldable housing in a fully folded closed position, providing a more compact form for portability and stowage;

FIG. 3B illustrates a side view of the electronic device having a foldable housing in a fully folded closed position, providing a more compact form for portability and stowage;

FIG. 4A illustrates a perspective view of the electronic device having a foldable housing in a partially unfolded angled position, according to one or more embodiments;

FIG. 4B illustrates another perspective view of the electronic device having a foldable housing in a partially unfolded angled position, according to one or more embodiments;

FIG. 5 illustrates a view of an environment in which a user is interfacing with the foldable electronic device while the foldable housing is in the partially unfolded angled position of FIGS. 4A-4B, with a second portion of the foldable housing being placed on a support surface and a first portion of the foldable housing extending upward away from the support surface, according to one or more embodiments;

FIG. 6A is a diagram illustrating an example in which a gaze of the user of the foldable electronic device is directed towards a first display portion embedded in the first portion of the foldable housing while the device is in the partially unfolded angled position, according to one or more embodiments;

FIG. 6B is a diagram illustrating an example in which a gaze of the user of the foldable electronic device is directed towards a second display portion embedded in the second portion of the foldable housing while the device is in the partially unfolded angled position, according to one or more embodiments;

FIG. 7A illustrates an example of a front view of the electronic device in which a system dialog is presented on the first display portion embedded in the first portion of the foldable housing when the user is actively interfacing with the first display portion while the device is in the partially unfolded angled position, according to one or more embodiments;

FIG. 7B illustrates an example of a top view of the electronic device in which a system dialog is presented on the second display portion embedded in the second portion of the foldable housing when the user is actively interfacing with the second display portion while the device is in the partially unfolded angled position, according to one or more embodiments;

FIG. 8A illustrates an example of a front view of the electronic device in which an application notification is presented on the first display portion embedded in the first portion of the foldable housing when the user is actively interfacing with the first display portion while the device is in the partially unfolded angled position, according to one or more embodiments;

FIG. 8B illustrates an example of a top view of the electronic device in which an application notification is presented on the second display portion embedded in the second portion of the foldable housing when the user is actively interfacing with the second display portion while the device is in the partially unfolded angled position, according to one or more embodiments;

FIG. 9 is a flowchart presenting operations of a method of managing the presentation of notifications and dialogs being presented on a foldable electronic device, according to one or more embodiments;

FIG. 10 is a flow diagram illustrating a method of managing the presentation of notifications and dialogs being presented on a foldable electronic device, according to one or more embodiments; and

FIG. 11 is a flow diagram illustrating a method for managing the presentation of notifications and dialogs being presented on a foldable electronic device, according to one or more embodiments.

### DETAILED DESCRIPTION

According to aspects of the present disclosure, an electronic device, a method, and a computer program product provide a solution for managing application notifications and system dialogs on a foldable electronic device having a foldable display with two separately-rendered display sections while the device is oriented in a laptop/flex mode. The electronic device has a foldable form factor that enables desktop placement in a partially unfolded position for handsfree viewing without the necessity of a holder or stand. However, in the partially unfolded position, a problem occurs when only one portion of the folding display of the electronic device is aligned with the current viewing angle of the user.

As noted above, when the mobile device is placed in a laptop mode or flex mode in which the foldable housing is placed in a partially unfolded angled position, corresponding means for presenting and accessing various application notifications and system dialogs (e.g., lockscreen, application notifications, volume slider, status bar, etc.) are not defined currently. In addition, when the mobile device is placed in the laptop/flex mode of view, typically the upper display portion of the mobile device is oriented substantially vertically and is clearly visible, while the lower display portion of the mobile device is oriented substantially horizontally and is significantly less visible (and thus, difficult to see and/or operate upon). As a result, viewing and accessing application notifications and system dialogs while in the laptop/flex mode can be particularly difficult if the notifications/dialogs are presented in the lower display portion and/or overlapping across the intermediate display portion (folded middle area). In addition, depending on the viewing angle of the user (e.g., front-facing view of top screen vs. top-down view of bottom screen), a particular portion of the device display (top or bottom) becomes more prominently visible while the other portion of the device display (bottom or top) becomes unviewable. Again, viewing and accessing the application notifications and system dialogs can be very difficult while in the laptop/flex mode if they are presented on the display portion which the user is not viewing and/or overlapping across the intermediate display portion (folded middle area). Thus, there is a need for improved techniques to make presenting and accessing notifications and dialogs while a foldable mobile device is placed in the laptop/flex mode more useful and convenient for the user.

The present disclosure addresses the aforementioned problem(s) with presenting notifications/dialogs in a top or bottom display portion of a divided display, where the notification/dialog is presented in one display portion that may not be viewable by the user or which the user is not currently paying attention to. According to one or more embodiments, the particular display portion of the divided display that the user is currently viewing or paying attention to is identified, and then the notifications/dialogs are presented on that particular display portion. According to one or more embodiments, the present disclosure provides presentation and control solutions for addressing the electronic device being in the partially unfolded position that makes only one of the upper portion and the lower portion viewable, while the other portion is difficult to view, by presenting the notifications/dialogs only on the most viewable portion of the divided display. By implementing the features described herein, the functionality and usability of the foldable electronic device by a user is improved.

In one or more embodiments, the electronic device has a folding display including a first display portion positioned on an inward side of the first housing portion and a second display portion positioned on an inward side of the second housing portion. A controller of the electronic device is communicatively coupled to the folding display. The controller configures the first electronic device to present a first logical display portion on the first display portion of the folding display and a second logical display portion on the second display portion of the folding display. In response to the first housing portion being in an angled position relative to the second housing portion (i.e., partially unfolded with each display portion being separately viewable), the controller configures the electronic device to modify a selected one of the first logical display portion or the second logical display portion to present at least one notification or dialog on the selected one of the first logical display portion or the second logical display portion with which the user is actively interfacing.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, similar elements can be provided with similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

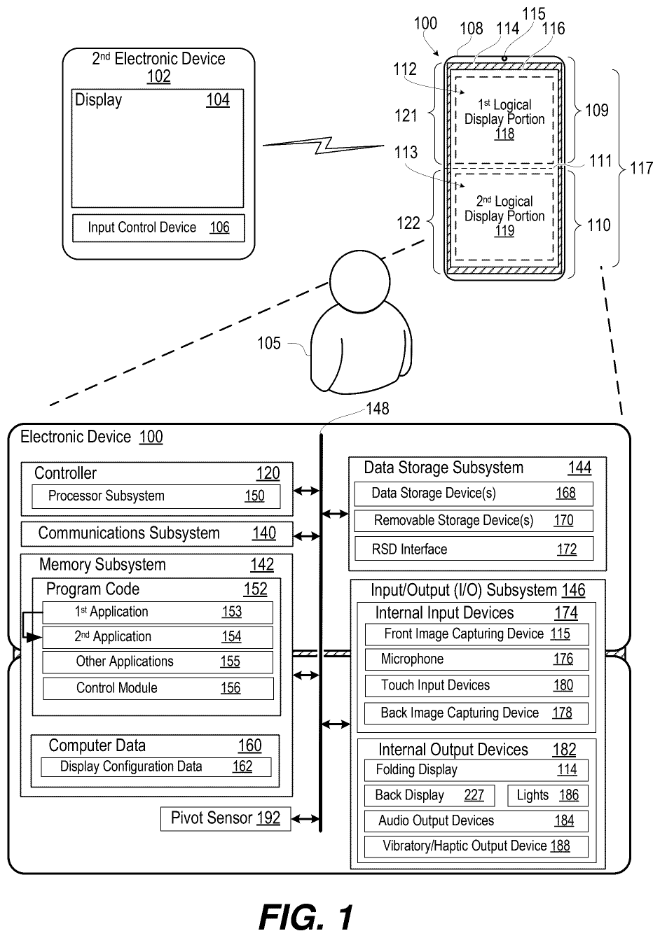

FIG. 1 presents a simplified functional block diagram of foldable electronic device 100 in which the features of the present disclosure are advantageously implemented for managing the presentation of application notifications and/or system dialogs on the foldable electronic device, depending on whether the device housing is in a partially unfolded (“angled”) position with each display portion separately viewable. In one or more embodiments, foldable electronic device 100 includes additional communications functionality that enables the electronic device to be interchangeably referred to as communication device 100, which operates as a mobile user device in a communication environment. In some examples, the communication environment can include at least one second electronic device 102, which includes display 104 and input control device 106, and to which electronic device 100 can communicatively couple and share interfaces and functions. It should be appreciated, however, that involvement of second communication device 102 is optional and may be omitted in various embodiments in which user 105 interacts with electronic device 100 directly.

Electronic device 100 can be one of a host of different types of devices, including but not limited to, a mobile cellular phone, satellite phone, or smart phone, a laptop, a netbook, an ultra-book, a networked smartwatch, or networked sports/exercise watch, and/or a tablet computing device or similar device that can include wireless communication functionality. As a device supporting wireless communication, electronic device 100 can be utilized as, and also be referred to as, a system, device, subscriber unit, subscriber station, mobile station (MS), mobile, mobile device, remote station, remote terminal, user terminal, terminal, user agent, user device, a session initiation protocol (SIP) phone, a wireless local loop (WLL) station, a personal digital assistant (PDA), computer workstation, a handheld device having wireless connection capability, a computing device, or other processing devices. Second electronic device 102 may also be one of the host of different types of devices described above.

In one or more embodiments, electronic device 100 (i.e., “a first electronic device”) includes foldable housing 108 that has a foldable form factor provided by first housing portion 109, second housing portion 110, and hinge 111 coupling first housing portion 109 to second housing portion 110. In FIG. 1, electronic device 100 is in a fully unfolded (open) position with folding display 114 extended across first front inner side 112 of first housing portion 109 and second front inner side 113 of second housing portion 110, respectively. Front image capturing device 115 is positioned on first housing portion 109. Electronic device 100 prepares logical display 116 of graphical content that is sized and assigned for presentation on folding display 114. Logical display 117 contains display information that has to be rendered and adjusted for display hardware that drives physical pixels of folding display 114. For displays that change size or availability, electronic device 100 can alter presentation and assignment of portions of logical display 117 depending on pivot position of foldable housing 108. In an example, logical display 117 may be separated into first logical display portion 118 and second logical display portion 119 that correspond, and are assigned for presentation by controller 120, to first display portion 121 and second display portion 122 of folding display 114, respectively. In some example embodiments, logical display 117 may be a single flexible display screen. In some other example embodiments, first logical display portion 118 and second logical display portion 119 may be distinct display screens (e.g., separated by a slim bezel at hinge 111). That is, folding display 114 can be or include two separate display components that are used to provide a substantially seamless presentation of display output when in the fully open position. Thus, the present disclosure also encompasses the concept of a dual display configuration that can seamlessly present information in the fully open position but does not necessarily have to be a contiguous display component that is flexible/foldable.

In addition to controller 120, electronic device 100 may include communications subsystem 140, memory subsystem 142, data storage subsystem 144, and input/output (I/O) subsystem 146. To enable management by controller 120, system interlink 148 communicatively connects controller 120 with communications subsystem 140, memory subsystem 142, data storage subsystem 144, and I/O subsystem 146. System interlink 148 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. Although certain direct interconnections (i.e., system interlink 148) are illustrated in FIG. 1, it is to be understood that more, fewer, or different interconnections may be present in other embodiments.

Controller 120 includes processor subsystem 150, which includes one or more central processing units (CPUs) or data processors. Processor subsystem 150 can include one or more digital signal processors that can be integrated with data processor(s). Processor subsystem 150 can include other processors such as auxiliary processor(s) that may act as a low power consumption, always-on sensor hub for physical sensors. Controller 120 manages, and in some instances directly controls, the various functions and/or operations of electronic device 100 via processor subsystem 150. These functions and/or operations include, but are not limited to including, application data processing, communication, navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic.

Memory subsystem 142 stores program code 152 for execution by processor subsystem 150 to provide the functionality described herein. Program code 152 includes applications such as first application 153, second application 154, and other applications 155 that generate portions of logical display 117. Memory subsystem 142 further includes operating system (OS), firmware interface, such as basic input/output system (BIOS) or Uniform Extensible Firmware Interface (UEFI), and firmware, which also includes and may thus be considered as program code 152. Control module 156 can be a universal input control module that enables cooperative control between electronic device 100 and second electronic device 102. When electronic device 100 communicatively couples to second electronic device 102, activation of control module 156 at electronic device 100 is triggered. Upon establishing communication via control module 156, each device 100 and 102 identifies to the other device 100 and 102, and input control device 106 can be available to act as a single input control for both electronic device 100 and second electronic device 102. Control module 156 enhances control capabilities by providing single input control even for partially unfolded devices such as electronic device 100. These applications/modules may be software or firmware that, when executed by controller 120, configures electronic device 100 to provide functionality described herein.

In one or more embodiments, several of the described aspects of the present disclosure are provided via executable program code of applications executed by controller 120 and/or processor subsystem 150. In one or more embodiments, program code 152 may be integrated into a distinct chipset or hardware module as firmware that operates separately from executable program code. Portions of program code 152 may be incorporated into different hardware components that operate in a distributed or collaborative manner.

Program code 152 may access, use, generate, modify, store, or communicate computer data 160, such as display configuration data 162 that supports, and is updated by, control module 156. Computer data 160 may incorporate “data” that originated as raw, real-world “analog” information that consists of basic facts and figures. Computer data 160 includes different forms of data, such as numerical data, images, coding, notes, and financial data. Computer data 160 may originate at electronic device 100 or be retrieved from a remote device via communications subsystem 140. Electronic device 100 may store, modify, present, or transmit computer data 160 such as display configuration data 162. Computer data 160 may be organized in one of a number of different data structures. Common examples of computer data 160 include video, graphics, text, and images. Computer data 160 can also be in other forms of flat files, databases, and other data structures.

Data storage subsystem 144 of electronic device 100 includes data storage device(s) 168. Controller 120 is communicatively connected, via system interlink 148, to data storage device(s) 168. Data storage subsystem 144 provides program code 152 and computer data 160 stored on nonvolatile storage that is accessible by controller 120. For example, data storage subsystem 144 can provide a selection of program code 152 and computer data 160. These applications can be loaded into memory subsystem 142 for execution and/or processing by controller 120. In one or more embodiments, data storage device(s) 168 can include hard disk drives (HDDs), optical disk drives, and/or solid-state drives (SSDs), etc. Data storage subsystem 144 of electronic device 100 can include removable storage device(s) (RSD) 170, which is received in RSD interface 172. Controller 120 is communicatively connected to RSD 170 via system interlink 148 and RSD interface 172. In one or more embodiments, RSD 170 is a non-transitory computer program product or computer readable storage device that includes program code/instructions that may be executed/processed by a processor associated with a user device such as electronic device 100. Controller 120 can access data storage device(s) 168 and/or RSD 170 to provision electronic device 100 with program code 152 and/or computer data 160.

Input/Output (I/O) subsystem 146 may include internal input devices 174 such as microphone 176, front image capturing device(s) 115 and back image capturing device(s) 178, and touch input devices 180 (e.g., screens, keys, or buttons). I/O subsystem 146 may include internal output devices 182 such as folding display 114, audio output devices 184, lights 186, vibratory/haptic output device 188, and back display 227. Internal input devices 174 may also include one or more sensors, such as pivot sensor 192 that detects and reports to processor subsystem 150 of controller 120 one or more states of foldable housing 108, from among: (i) a fully folded (“closed”) position, (ii) a partially unfolded (“angled”) position; and (iii) a fully unfolded (“open”) position. In some example embodiments, pivot sensor 192 can detect one or more discrete values or a continuous range of values corresponding to different angles between first housing portion 109 and second housing portion 110 of foldable housing 108. In one or more embodiments, a pre-established minimum angle (e.g., 90 degrees) may be preset to corresponds to an open angle at which the features of the disclosure are triggered, in part based on the ability of front image capturing device 115 to identify a view angle or view-ability of the user relative to the two distinct portions of folding display 114.

In one or more embodiments, controller 120, via communications subsystem 140, performs multiple types of cellular over-the-air (OTA) or wireless communication, such as by using a Bluetooth connection or other personal access network (PAN) connection. In an example, a user may wear a health monitoring device such as a smartwatch that is communicatively coupled via a wireless connection. In one or more embodiments, communications subsystem 140 includes a global positioning system (GPS) module that receives GPS broadcasts from GPS satellites to obtain geospatial location information. In one or more embodiments, controller 120, via communications subsystem 140, communicates via a wireless local area network (WLAN) link using one or more IEEE 802.11 WLAN protocols with an access point. In one or more embodiments, controller 120, via communications subsystem 140, may communicate via an OTA cellular connection with radio access networks (RANs). In an example, electronic device 100, via communications subsystem 140, connects via RANs of a terrestrial network that is communicatively connected to a network server. In one or more embodiments, electronic device 100 can communicate, via one or more available interfaces within communications subsystem 140, with one or more second electronic devices 102, which may be user devices, network devices, and/or servers and receive notifications from one or more of these second electronic devices 102 for surfacing on the folding display 114.

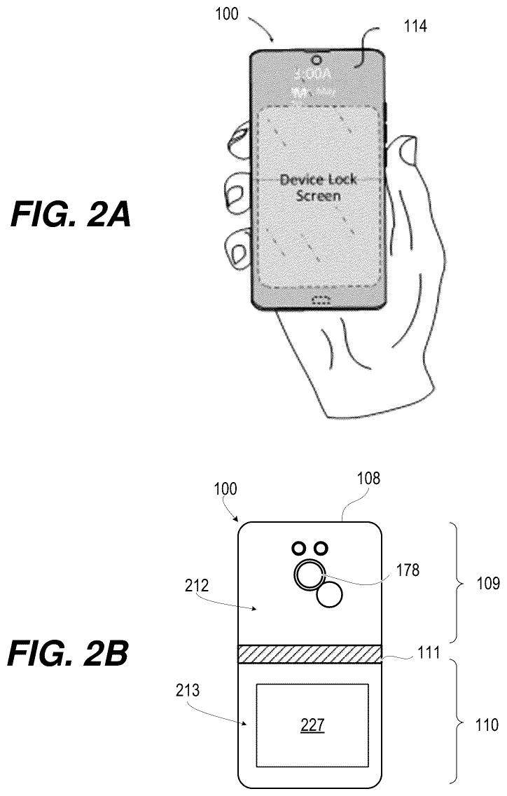

FIG. 2A illustrates a front view of electronic device 100 having foldable housing 108 in a fully unfolded (open) position. In FIG. 2A, a device lock screen is presented on folding display 114. FIG. 2B illustrates a back view of electronic device 100 having foldable housing 108 in a fully unfolded (open) position. As shown in FIG. 2B, first back side 212 of first housing portion 109 provides back image capturing devices 178, and second back side 213 of second housing portion 110 provides back display 227, which is always exposed independent of pivoting of foldable housing 108.

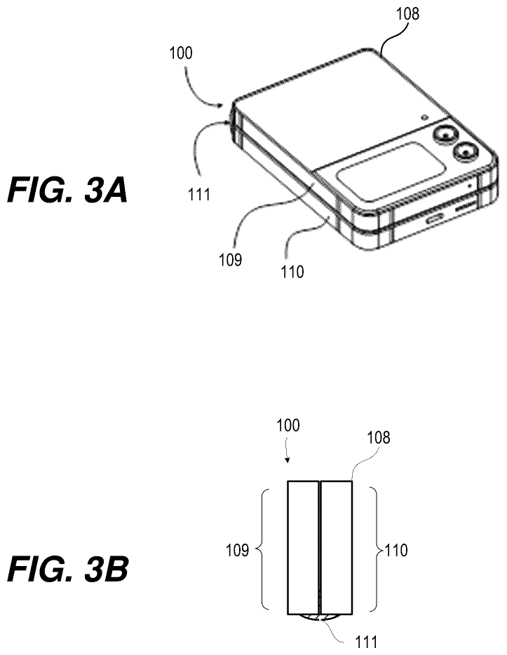

FIG. 3A illustrates a perspective view of electronic device 100 having foldable housing 108 in a fully folded (closed) position. FIG. 3B illustrates a side view of electronic device 100 having a foldable housing 108 in a fully folded (closed) position. The foldable housing 108 of electronic device 100 has first housing portion 109 and second housing portion 110, which are fully folded (pivoted together), thereby hiding folding display 114 (FIGS. 1 and 2A). Configuring electronic device 100 in the fully folded closed position as shown in FIGS. 3A-3B provides a more compact form for portability and stowage.

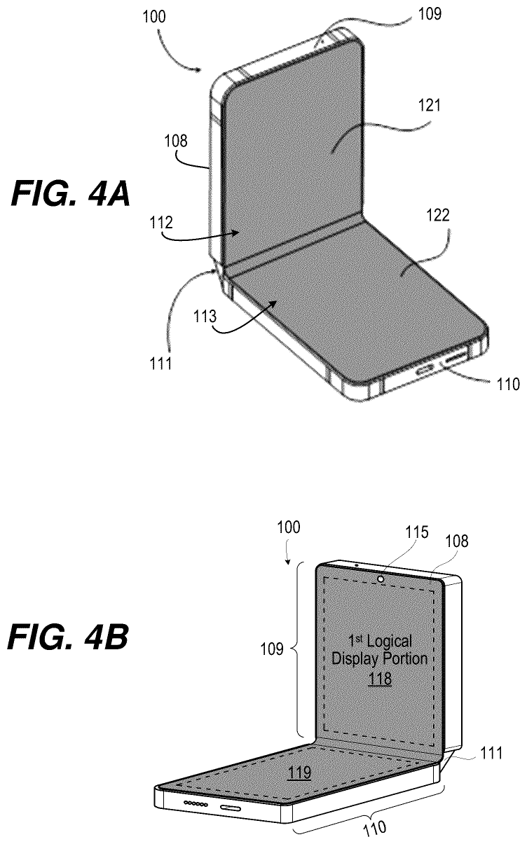

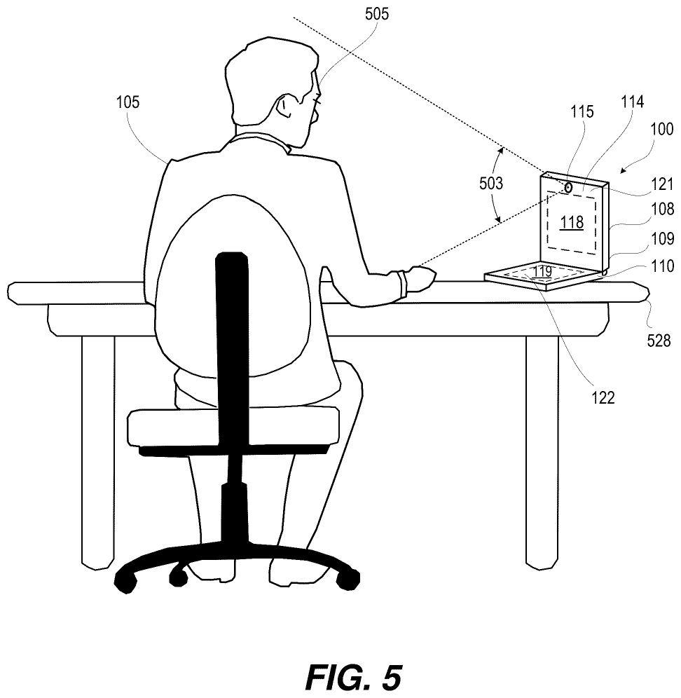

FIG. 4A and FIG. 4B illustrate perspective views of electronic device 100 having foldable housing 108 in a partially unfolded (angled) position, according to one or more embodiments. The second housing portion 110 can be placed on and aligned with a support surface such as a table or desk (e.g., refer to support surface 528 of FIG. 5), with foldable housing 108 partially unfolded to present first housing portion 109 generally upward in an angled position. The partially unfolded or angled position may also be referred to as a “laptop” mode, due to appearing similarly to the way laptops are typically positioned for use. Likewise, the partially unfolded or angled position is sometimes referred to as a “flex” mode (e.g., alluding to the flexible nature of the display screen according to some example embodiments). One or more aspects of the present disclosure are particularly applicable to electronic device 100 when foldable housing 108 is configured in the partially unfolded angled position presented by FIG. 4A - 4B.

FIG. 5 illustrates a view of an environment in which user 105 is interfacing with electronic device 100 while foldable housing 108 is in the partially unfolded angled position (e.g., FIGS. 4A-4B) , with second housing portion 110 of foldable housing 108 being placed on support surface 528 and first housing portion 109 of foldable housing 108 extending upward away from support surface 528, according to one or more embodiments. According to aspects of the present disclosure, with reference again to FIG. 1, controller 120 configures electronic device 100 to present first logical display portion 118 on first display portion 121 of folding display 114 and to present second logical display portion 119 on second display portion 122 of folding display 114.

In the example shown in FIG. 5, user 105 is positioned in front of first display portion 121 (first logical display portion 118) of folding display 114 on first housing portion 109 of foldable housing 108, but can also be presented with content on the “hidden” or “flattened” display, which corresponds to second display portion 122 (second logical display portion 119) of folding display 114 on second housing portion 110 of foldable housing 108 in this example. However, the skewed position (i.e., non-orthogonal) of user 105 in relation to second display portion 122 of folding display 114 may exceed a viewing angle at which the visual content or image (i.e., second logical display portion 119 in this example) can be viewed with an acceptable visual performance. The viewing angle may be defined in an angular range as a viewing cone, for example. The visual content or image presented in second logical display portion 119 of second display portion 122 may seem garbled, poorly saturated, of poor contrast, blurry, or too faint outside the stated viewing angle range. The exact mode of “failure” may depend on the display type of folding display 114. For example, some projection screens reflect more light perpendicular to the screen and less light to the sides, making the screen appear much darker (and sometimes colors distorted) if the viewer is not directly in front of and/or looking directly at the screen. For other display technologies viewable from a wider viewing angle, the “failure” may be wholly based on the angular skewed presentation, compressing the visual content or image.

In one or more embodiments, with reference again to FIG. 1, controller 120 configures electronic device 100 to detect folding display 114 being in the angled position based on position or movement input from pivot sensor 192, which is communicatively coupled to controller 120. In response, at least in part, to first housing portion 109 being in an angled position relative to second housing portion 110, controller 120, when rendering application notifications and system dialogs for presentation, configures electronic device 100 to perform various operations of the techniques described herein to optimize the presentation of the notification/dialog on only one of first display portion 121 (via first logical display portion 118) or second display portion 121 (via second logical display portion 119) of folding display 114, depending on the respective display portion of folding display 114 that user 105 is currently positioned to view most clearly, or with which user 105 is otherwise actively interfacing (e.g., via touch screen interaction, etc.).

In the specific example of FIG. 5, front image capturing device 115 has front field of view (FOV) 503 that can be used to detect when any human face and/or an individually recognized face 505 of user 105, is positioned in front of folding display 114. In one embodiment, the presence of a human face while electronic device 100 is in the partially unfolded state (e.g., as detected by pivot sensor 192 (FIG. 1)) serves, in part, as a trigger for enabling/implementing various monitoring, processing, and display optimization techniques as further described below. With particular reference to FIG. 5, front image capturing device 115 can be used by controller 120 to detect that user 105 is aligned with the visible vertical display screen (first display portion 121 of folding display 114) on first housing portion 109 of foldable housing 108. Conversely, front image capturing device 115 can be used by controller 120 to detect that user 105 is in a skewed position (i.e., non-orthogonal) from the “hidden” or “flattened” display screen (second display portion 122 of folding display 114) on second housing portion 110 of foldable housing 108. Controller 120 can then configure electronic device 100 to present the notification/dialog on first logical display portion 118 of first display portion 121 in response to identifying the respective display portion of folding display 114 that user 105 is currently viewing or otherwise interfacing/interacting.

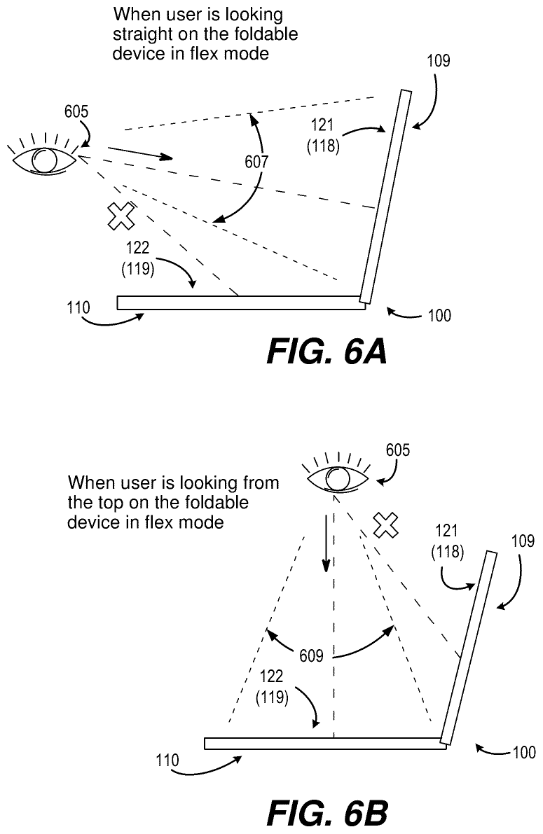

FIG. 6A is a diagram illustrating an example in which a gaze of user 105 of electronic device 100 is directed towards first display portion 121 embedded in first housing portion 109 while foldable housing 108 is in the partially unfolded angled position, according to one or more embodiments. In FIG. 6A, user 105 is looking straight on while foldable housing 108 of electronic device 100 is configured in laptop/flex mode. As shown in FIG. 6A, eye 605 of user 105 has first viewing angle 607 (front viewing angle) that is directed towards first logical display portion 118 of first display portion 121. In the specific example of FIG. 6A, first logical display portion 118 of first display portion 121 is clearly visible to eye 605 of user 105, whereas second logical display portion 119 of second display portion 122 is darker and less visible to eye 605 of user 105, due to the position of eye 605 and corresponding first viewing angle 607 in relation to the respective portions of folding display 114 of electronic device 100.

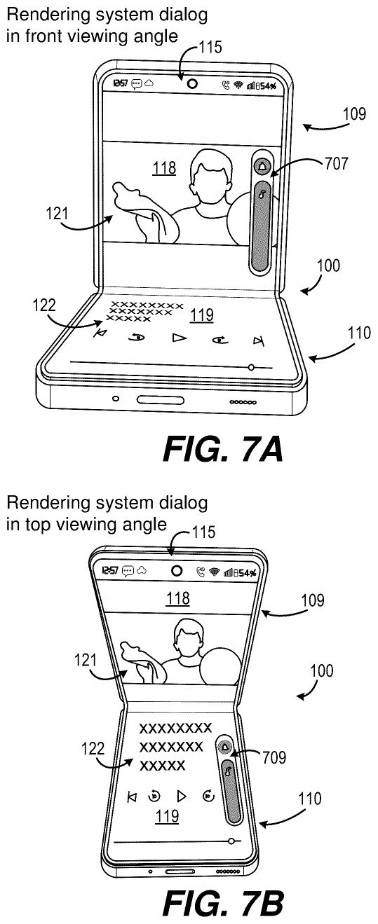

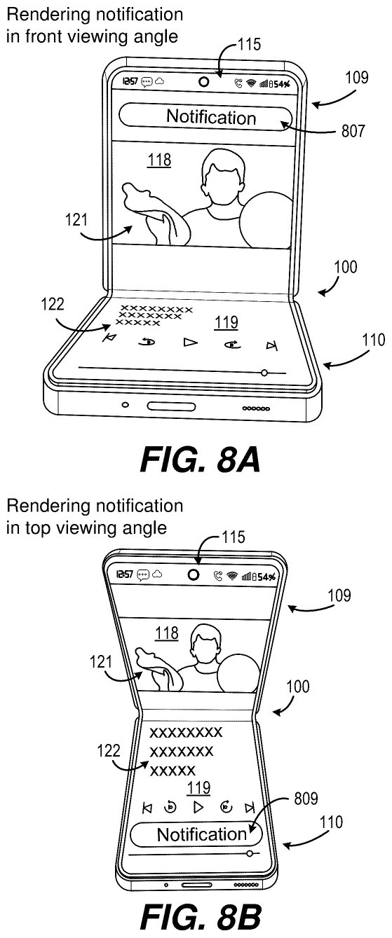

In one or more embodiments, front image capturing device 115 captures an image of face 505 of user 105, in which eye 605 of user 105 is viewing first logical display portion 118 of first display portion 121. Front image capturing device 115 transmits the image to controller 120 (e.g., processor subsystem 150, an AI engine, etc.) that analyzes the image input to identify (e.g., determine based on first viewing angle 607) that user 105 is looking towards/at/in the direction of first display portion 121. In one or more embodiments, at least while electronic device 100 is placed in the laptop/flex mode, controller 120 configures electronic device 100 to present an application notification or a system dialog on first logical display portion 118 of first display portion 121 embedded in first housing portion 109 based at least in part on identifying, in the image captured by front image capturing device 115, face 505 (FIG. 5) of user 105 viewing first display portion 121 of folding display 114 (e.g., based on first viewing angle 607 of eye 605) as shown in the example of FIG. 6A. Thus, the notifications/dialogs are presented via the upper/vertical display portion of the device when user 105 is currently looking there. Specific illustrative examples will be described below with reference to FIG. 7A and FIG. 8A.

FIG. 6B is a diagram illustrating an example in which a gaze of user 105 of electronic device 100 is directed towards second display portion 122 embedded in second housing portion 110 while foldable housing 108 is in the partially unfolded angled position, according to one or more embodiments. In FIG. 6B, user 105 is looking from the top down while foldable housing 108 of electronic device 100 is configured in laptop/flex mode. As shown in FIG. 6B, eye 605 of user 105 has second viewing angle 609 (top viewing angle) that is directed towards second logical display portion 119 of second display portion 122. In the specific example of FIG. 6B, second logical display portion 119 of second display portion 122 is clearly visible to eye 605 of user 105, whereas first logical display portion 118 of first display portion 121 is darker and less visible to eye 605 of user 105, due to the position of eye 605 and corresponding second viewing angle 609 in relation to the respective portions of folding display 114 of electronic device 100.

In one or more embodiments, front image capturing device 115 captures an image of face 505 of user 105, in which eye 605 of user 105 is viewing second logical display portion 119 of second display portion 122. Front image capturing device 115 transmits the image to controller 120 (e.g., processor subsystem 150, an AI engine, etc.) that analyzes the image input to identify (e.g., determine based on second viewing angle 609) that user 105 is looking towards/at/in the direction of second display portion 122. In one or more embodiments, at least while electronic device 100 is placed in the laptop/flex mode, controller 120 configures electronic device 100 to present an application notification or a system dialog on second logical display portion 119 of second display portion 122 embedded in second housing portion 110 based at least in part on identifying, in the image captured by front image capturing device 115, face 505 (FIG. 5) of user 105 viewing second display portion 122 of folding display 114 (e.g., based on second viewing angle 609 of eye 605) as shown in the example of FIG. 6B. Thus, the notifications/dialogs are presented via the lower/horizontal display portion of the device when user 105 is currently looking there. Specific illustrative examples will be described below with reference to FIG. 7B and FIG. 8B.

It should be appreciated that example embodiments are not limited to techniques involving facial recognition and/or gaze detection (e.g., based on monitoring front image capturing device 115 for images of face 505 and/or eyes 605 of user 105). In one or more alternative embodiments, controller 120 configures electronic device 100 to present an application notification or a system dialog on a respective one of first logical display portion 118 of first display portion 121 or second logical display portion 119 of second display portion 122 (refer to FIGS. 7A-7B and FIGS. 8A-8B) based at least in part on determining that user 105 is actively interfacing with (e.g., touching one or more features presented on, or otherwise interacting with) the respective one of first display portion 121 or second display portion 122.

In one non-limiting illustrative example use case, user 105 can place electronic device 100 in the laptop/flex mode (as described above with reference to FIGS. 4A-4B, FIG. 5, and FIGS. 6A-6B) while watching a video, which adjusts the video content window to the top vertical display portion of the screen (first logical display portion 118 of first display portion 121) with the video information and playback controls on the bottom horizontal display portion of the screen (second logical display portion 119 of second display portion 122), thus enabling user 105 a convenient hands-free video viewing experience. However, adjusting the volume level of the video is cumbersome in the laptop/flex mode. The presentation (i.e., rendering, modifying, displaying, etc.) of a volume slider bar can be triggered in various ways, such as by the user touching a screen, the user touching a button on the side of foldable housing 108, the user issuing a voice command to “adjust volume,” etc., for example. According to existing schemes, the volume slider bar is not clearly visible in its entirety when the electronic device 100 is in the laptop/flex mode, since the volume slider bar typically overlaps across the partially folded intermediate portion of the display screen and extends onto the bottom horizontal display portion. Picking up the device to adjust the volume level breaks the whole interaction and defeats the purpose of the laptop/flex mode. As another example scenario, the display screen may auto lock due to inactivity, causing video playback on the device to be paused and requiring entry of a user credential to unlock the device and resume the video playback. With the device in the flex mode, the unlock PIN interface can be presented across both screens, making the interface difficult to access, or presented on the bottom horizontal display portion of the display where it is not visible to the user. To address these and other similar needs, an improved technique for leveraging both the top display portion and the bottom display portion of a foldable mobile device when the device is placed in laptop/flex mode is provided herein and is further described below with reference to FIGS. 7A-7B and FIGS. 8A-8B. The features of these figures are described with a selected display portion being dependent upon the direction in which the user is looking, as described above with reference to FIGS. 6A-6B, or with the selected display portion otherwise being dependent upon the particular portion of the display with which the user is currently interfacing.

FIG. 7A illustrates an example of a front view of electronic device 100 in which a system dialog is presented on first display portion 121 embedded in first housing portion 109 when user 105 is actively interfacing with first logical display portion 118 while foldable housing 108 is in the partially unfolded angled position, according to one or more embodiments. In the example of FIG. 7A, a gaze of user 105 of electronic device 100 is directed towards first display portion 121 embedded in first housing portion 109 while foldable housing 108 is in the partially unfolded angled position. In FIG. 7A, user 105 is looking straight on while foldable housing 108 of electronic device 100 is configured in laptop/flex mode. In this example, user 105 has a viewing angle (e.g., first viewing angle 607 of FIG. 6A) that is directed towards first logical display portion 118 of first display portion 121. In the specific example of FIG. 7A, first logical display portion 118 of first display portion 121 is clearly visible to the user, whereas second logical display portion 119 of second display portion 122 is darker and less visible to the user, due to the corresponding viewing angle with respect to the respective portions of folding display 114 of electronic device 100.

At least while electronic device 100 is placed in the laptop/flex mode, controller 120 configures electronic device 100 to present a system dialog (e.g., volume slider bar 707) on first logical display portion 118 of first display portion 121 embedded in first housing portion 109 utilizing the techniques described above. As noted, the presentation (i.e., rendering, modifying, displaying, etc.) of volume slider bar 707 can be triggered in various ways (e.g., user touching top screen, user touching a button on the side of foldable housing 108, user issuing a voice command to “adjust volume,” etc.), for example. Thus, a system dialog (volume slider bar 707) is presented via the upper/vertical display portion of the device in the example of FIG. 7A, so as to catch the attention of the user who is looking at/interfacing with the upper/vertical display portion of the device. This technique also ensures that there is no overlapping presentation of volume slider bar 707 across both screens.

FIG. 7B illustrates an example of a top view of electronic device 100 in which a system dialog is presented on second display portion 122 embedded in second housing portion 110 when user 105 is actively interfacing with second logical display portion 119 while foldable housing 108 is in the partially unfolded angled position, according to one or more embodiments. In the example of FIG. 7B, a gaze of user 105 of electronic device 100 is directed towards second display portion 122 embedded in second housing portion 110 while foldable housing 108 is in the partially unfolded angled position. In FIG. 7B, user 105 is looking from the top down while foldable housing 108 of electronic device 100 is configured in laptop/flex mode. In this example, user 105 has a viewing angle (e.g., second viewing angle 609 of FIG. 6B) that is directed towards second logical display portion 119 of second display portion 122. In the specific example of FIG. 7B, second logical display portion 119 of second display portion 122 is clearly visible to the user, whereas first logical display portion 118 of first display portion 121 is darker and less visible to the user, due to the corresponding viewing angle with respect to the respective portions of folding display 114 of electronic device 100.

At least while electronic device 100 is placed in the laptop/flex mode, controller 120 configures electronic device 100 to present a system dialog (e.g., volume slider bar 709) on second logical display portion 119 of second display portion 122 embedded in second housing portion 110 utilizing the techniques described above. As noted, the presentation (i.e., rendering modifying, displaying, etc.) of volume slider bar 709 can be triggered in various ways (e.g., user touching bottom screen, user touching a button on the side of foldable housing 108, user issuing a voice command to “adjust volume,” etc.), for example. Thus, a system dialog (volume slider bar 709) is presented via the lower/horizontal display portion of the device in the example of FIG. 7B, so as to catch the attention of the user who is looking at/interfacing with the lower/horizontal display portion of the device. This technique also ensures that there is no overlapping presentation of volume slider bar 709 across both screens.

FIG. 8A illustrates an example of a front view of electronic device 100 in which an application notification is presented on first display portion 121 embedded in first housing portion 109 when user 105 is actively interfacing with first logical display portion 118 while foldable housing 108 is in the partially unfolded angled position, according to one or more embodiments. In the example of FIG. 8A, a gaze of user 105 of electronic device 100 is directed towards first display portion 121 embedded in first housing portion 109 while foldable housing 108 is in the partially unfolded angled position (i.e., user 105 is looking straight on while foldable housing 108 of electronic device 100 is configured in laptop/flex mode). In this example, user 105 has a viewing angle (e.g., first viewing angle 607 of FIG. 6A) that is directed towards first logical display portion 118 of first display portion 121. Again, first logical display portion 118 of first display portion 121 is clearly visible to the user, whereas second logical display portion 119 of second display portion 122 is darker and less visible to the user, due to the corresponding viewing angle with respect to the respective portions of folding display 114 of electronic device 100.

At least while electronic device 100 is placed in the laptop/flex mode, controller 120 configures electronic device 100 to present an application notification (e.g., notification bar 807) on first logical display portion 118 of first display portion 121 embedded in first housing portion 109 utilizing the techniques described above. The presentation (i.e., rendering, modifying, displaying, etc.) of notification bar 807 can be triggered in various ways (e.g., upon receiving/detecting incoming notifications such as a text message alert, an email message alert, a multi-factor authentication alert, etc.). Thus, an application notification (notification bar 807) is presented via the upper/vertical display portion of the device in the example of FIG. 8A, so as to catch the attention of the user who is looking at/interfacing with the upper/vertical display portion of the device. This technique also ensures that there is no overlapping presentation of notification bar 807 across both screens.

FIG. 8B illustrates an example of a top view of electronic device 100 in which an application notification is presented on second display portion 122 embedded in second housing portion 110 when user 105 is actively interfacing with second logical display portion 119 while foldable housing 108 is in the partially unfolded angled position, according to one or more embodiments. In the example of FIG. 8B, a gaze of user 105 of electronic device 100 is directed towards second display portion 122 embedded in second housing portion 110 while foldable housing 108 is in the partially unfolded angled position (i.e., user 105 is looking from the top down while foldable housing 108 of electric device 100 is configured in laptop/flex mode). In this example, user 105 has a viewing angle (e.g., second viewing angle 609 of FIG. 6B) that is directed towards second logical display portion 119 of second display portion 122. Again, second logical display portion 119 of second display portion 122 is clearly visible to the user, whereas first logical display portion 118 of first display portion 121 is darker and less visible to the user, due to the corresponding viewing angle with respect to the respective portions of folding display 114 of electronic device 100.

At least while electronic device 100 is placed in the laptop/flex mode, controller 120 configures electronic device 100 to present an application notification (e.g., notification bar 809) on second logical display portion 119 of second display portion 122 embedded in second housing portion 110 utilizing the techniques described above. As noted, the presentation (e.g., rendering, modifying, displaying, etc.) of notification bar 809 can be triggered in various ways (e.g., upon receiving/detecting incoming notifications such as a text message alert, an email message alert, a multi-factor authentication alert, etc.). Thus, an application notification (notification bar 809) is presented via the lower/horizontal display portion of the device in the example of FIG. 8B, so as to catch the attention of the user who is looking at/interfacing with the lower/horizontal display portion of the device. This technique also ensures that there is no overlapping presentation of notification bar 809 across both screens.

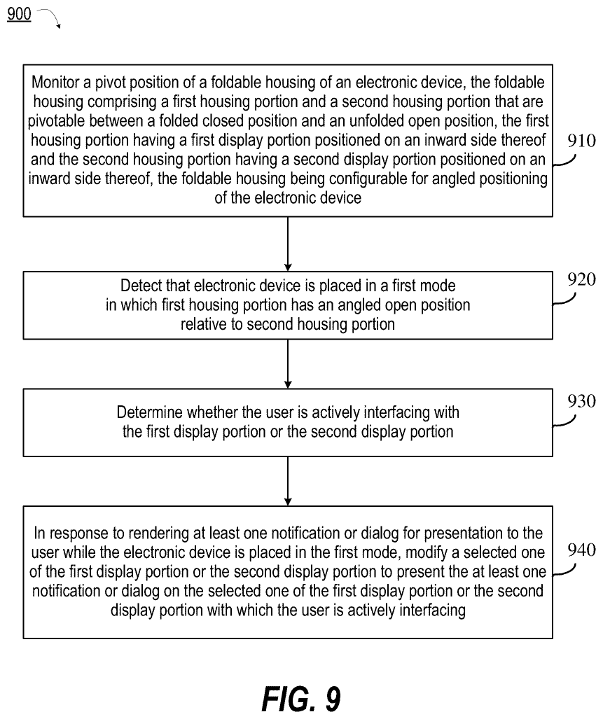

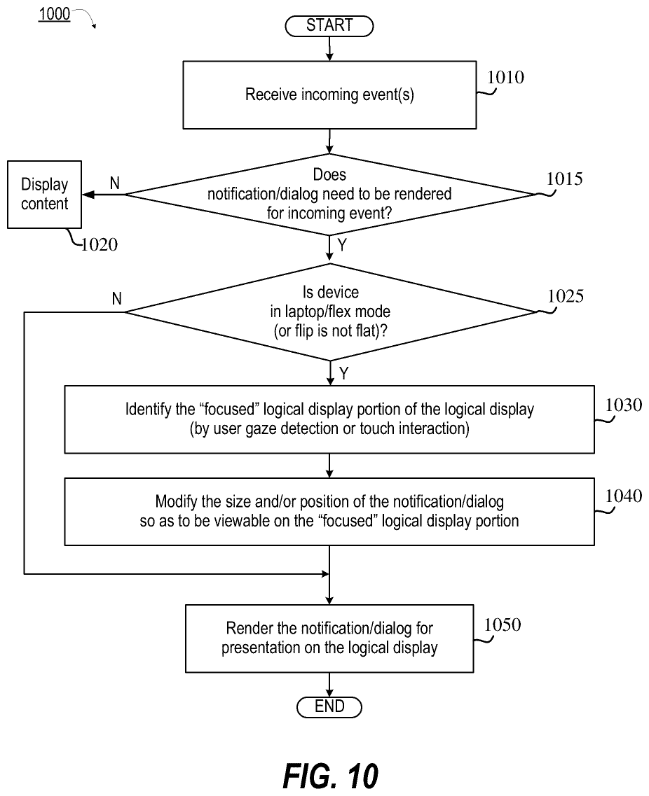

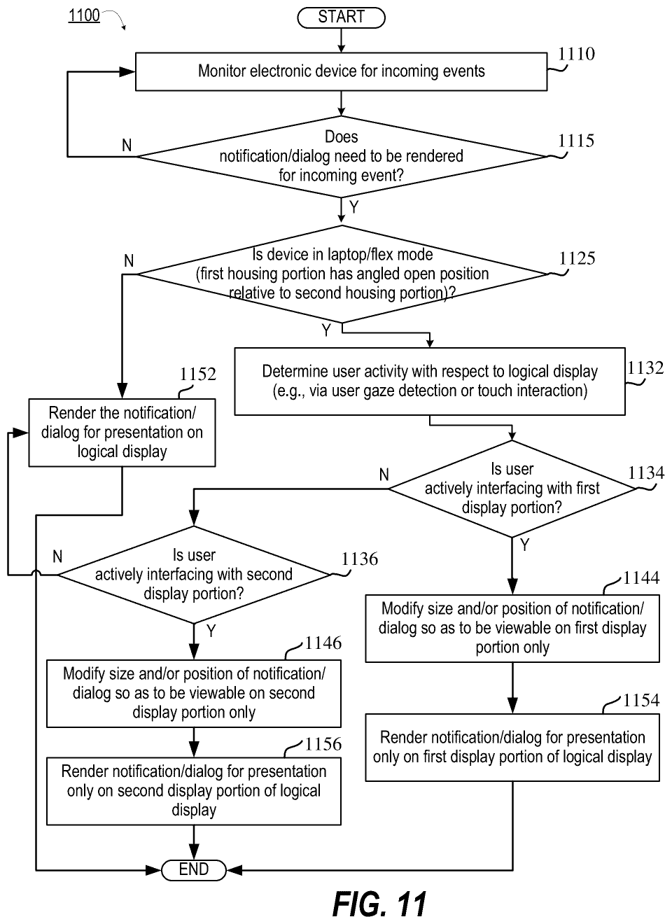

FIGS. 9, 10, and 11 present flow charts of different processes described as method 900, method 1000, and method 1100, respectively, for performing various features of the disclosure. The following descriptions of method 900 (FIG. 9), method 1000 (FIG. 10), and method 1100 (FIG. 11) are provided with general reference to the specific components illustrated within the preceding figures. Specific components referenced in method 900 (FIG. 9), method 1000 (FIG. 10), and method 1100 (FIG. 11) may be identical or similar to components of the same name used in describing the preceding figures. In one or more embodiments, controller 120 (FIG. 1) configures electronic device 100 (FIG. 1) or a similar computing device to provide the described functionality of method 900 (FIG. 9), method 1000 (FIG. 10), and method 1100 (FIG. 11).

FIG. 9 is a flowchart presenting method 900 of managing the presentation of notifications and dialogs being presented on a foldable electronic device, according to one or more embodiments. Method 900 can be implemented by an electronic device that includes at least: (1) a foldable housing including at least a first housing portion and a second housing portion that are pivotable between a folded closed position and an unfolded open position, the foldable housing being configurable for angled positioning of the electronic device; (2) a foldable display including a first display portion positioned on an inward side of the first housing portion and a second display portion positioned on an inward side of the second housing portion; (3) at least one image capturing device positioned on the inward side of the first housing portion; (4) a memory having stored thereon a control module for controlling the at least one image capturing device and the foldable display; and (5) at least one processor communicatively coupled to the foldable display, the at least one image capturing device, and the memory, the at least one processor being operable to execute program code of the control module and configured to cause the electronic device to perform corresponding operations of method 900.

With reference to FIG. 9, method 900 includes monitoring a pivot position of a foldable housing of an electronic device (block 910). The foldable housing comprises a first housing portion and a second housing portion that are pivotable between a folded closed position and an unfolded open position, the first housing portion having a first display portion positioned on an inward side thereof and the second housing portion having a second display portion positioned on an inward side thereof. The foldable housing is configurable for angled positioning of the electronic device. Method 900 includes detecting that the electronic device is placed in a first mode in which the first housing portion has an angled open position relative to the second housing portion, with both display portions being separately viewable based on a viewing angle of the user (block 920). In some examples, method 900 can include detecting, via at least one pivot sensor of the electronic device, that the electronic device is placed in the first mode in which the first housing portion has the angled position relative to the second housing portion (at block 920).

Then, method 900 includes determining whether the user is actively interfacing with the first display portion or the second display portion (block 930). In response to rendering at least one notification or dialog for presentation to the user while the electronic device is placed in the first mode, method 900 further includes modifying a selected one of the first display portion or the second display portion to present the at least one notification or dialog on the selected one of the first display portion or the second display portion with which the user is actively interfacing (block 940).

In some examples, determining whether the user is actively interfacing with the first display portion or the second display portion (at block 930) includes monitoring a field of view of at least one image capturing device of the electronic device, determining a viewing angle of the user based on the field of view encompassing the face of the user, and detecting that the user has a gaze directed toward a specific one of the first display portion of the first housing portion or the second display portion of the second housing portion based at least in part on the viewing angle of the user. In some other examples, determining whether the user is actively interfacing with the first display portion or the second display portion (at block 930) includes detecting that the user is actively interacting with features presented on a specific one of the first display portion or the second display portion.

In some examples, responsive to determining that the user is actively interfacing with the second display portion of the second housing portion, method 900 further includes designating the second display portion as a primary viewing screen for the user, and modifying the second display portion to render the at least one notification or dialog for presentation only on the second display portion with which the user is actively interfacing and that is currently designated as the primary viewing screen for the user. In some examples, responsive to subsequently determining that the user is actively interfacing with the first display portion of the first housing portion, method 900 further includes designating the first display portion as the primary viewing screen for the user, and modifying the second display portion and the first display portion to render the at least one notification or dialog for presentation only on the first display portion with which the user is actively interfacing and that is currently designated as the primary viewing screen for the user.

In some examples, while the electronic device is placed in the first mode in which the first housing portion has an angled position relative to the second housing portion, method 900 further includes determining that the user has transitioned to actively interfacing with a different one of the first display portion of the first housing portion or the second display portion of the second housing portion, and in response to rendering at least one subsequently received notification or dialog for presentation to the user while the electronic device is placed in the first mode, modifying the different one of the first display portion or the second display portion to present the at least one subsequently received notification or dialog on the different one of the first display portion or the second display portion with which the user is actively interfacing.

FIG. 10 is a flow diagram illustrating method 1000 for managing the presentation of notifications and dialogs being presented on a foldable electronic device, according to one or more embodiments. With reference to FIG. 10, method 1000 includes receiving, by a processor (controller) of an electronic device, one or more incoming event(s) (block 1010). A determination is made regarding whether an application notification or a system dialog needs to be rendered for the incoming event (decision block 1015). If a notification/dialog does not need to be rendered for the incoming event (“No” at decision block 1015), then the displayed content is presented as normal on respective display portions, and the process ends (block 1020). If a notification/dialog needs to be rendered for the incoming event (“Yes” at decision block 1015), then a determination is made regarding whether the electronic device is in a laptop/flex mode, in which a first housing portion of a foldable housing of the electronic device is placed in a partially open angled position with respect to a second housing portion of the foldable housing of the electronic device (decision block 1025).

If the electronic device is in the laptop/flex mode (“Yes” at decision block 1025), then the “focused” logical display portion of the logical display is identified (block 1030). This identification can be performed by utilizing user gaze detection and/or touch interaction, as described above, or another suitable techniques for detecting how the user is interfacing with a particular logical display portion of the display screen of the electronic device. Method 1000 includes modifying the size and/or position of the notification/dialog so as to be viewable on the “focused” logical display portion (block 1040). Method 1000 further includes rendering the notification/dialog for presentation on the logical display (block 1050). On the other hand, if the electronic device is not in the laptop/flex mode (“No” at decision block 1025), method 1000 proceeds directly (i.e., bypassing block 1030 and block 1040) to render the notification/dialog for presentation on the logical display at a normal rendered position for such dialog (block 1050).

FIG. 11 is a flow diagram illustrating method 1100 for managing the presentation of notifications and dialogs being presented on a foldable electronic device, according to one or more embodiments. With reference to FIG. 11, method 1100 includes monitoring, by a processor (controller) of an electronic device, for incoming events (block 1110). A determination is made regarding whether an application notification or a system dialog needs to be rendered for an incoming event (decision block 1115). If a notification/dialog does not need to be rendered for the incoming event (“No” at decision block 1115), then the processor/controller continues monitoring for incoming events (at block 1110). If a notification/dialog needs to be rendered for the incoming event (“Yes” at decision block 1115), then a determination is made regarding whether the electronic device is in a laptop/flex mode, in which a first housing portion of a foldable housing of the electronic device has a partially open angled position relative to a second housing portion of the foldable housing of the electronic device (decision block 1125).

If the electronic device is in the laptop/flex mode (“Yes” at decision block 1125), then the processor/controller determines user activity with respect to the logical display (block 1132). A determination is made regarding whether the user is actively interfacing with the first display portion (decision block 1134). As described, identifying the “focused” logical display portion of the logical display can be performed by utilizing user gaze detection, touch interaction, or another suitable technique for detecting how the user is interfacing with a particular logical display portion of the display screen of the electronic device. If the user is actively interfacing with the first display portion (“Yes” at decision block 1134), then method 1100 includes modifying the size and/or position of the notification/dialog so as to be viewable on the first display portion only (block 1144) and rendering the notification/dialog for presentation only on the first display portion of the logical display (block 1154). If the user is not actively interfacing with the first display portion (“No” at decision block 1134), then a determination is made regarding whether the user is actively interfacing with the second display portion (decision block 1136). If the user is actively interfacing with the second display portion (“Yes” at decision block 1136), then method 1100 includes modifying the size and/or position of the notification/dialog so as to be viewable on the second display portion only (block 1146) and rendering the notification/dialog for presentation only on the second display portion of the logical display (block 1156).

On the other hand, if the electronic device is not in the laptop/flex mode (“No” at decision block 1125), method 1100 proceeds directly to render the notification/dialog for presentation on the logical display in the normal rendered position for such notification/dialog in a full display view configuration (block 1152). Similarly, if the user is not actively interfacing with the second display portion (“No” at decision block 1136), then method 1100 can proceed to render the notification/dialog for presentation on the logical display in the normal rendered position for such notification/dialog in a split logical display view configuration (block 1152), or otherwise ends. For example, the processor/controller can select one of the first display portion or the second display portion by default (e.g., the top screen), based on the previous or most recent selection of the “focused” display portion, or based on using another suitable criteria or customized user setting.

In some example embodiments, method 1000 and/or method 1100 can include monitoring, by the processor/controller of the electronic device, a pivot sensor that detects a pivot position of a foldable housing of the electronic device. In one or more embodiments, the foldable housing includes a first housing portion, a second housing portion, and a hinge coupling the first housing portion to the second housing portion. The first housing portion is pivotable about the hinge relative to the second housing portion between a folded closed position and an unfolded open position. The foldable housing is configured for angled positioning on a support surface with the second housing portion positioned on and aligned with the support surface and the first housing portion oriented away from the support surface. The electronic device has a folding display including a first display portion positioned on an inward side of the first housing portion and a second display portion positioned on an inward side of the second housing portion. In some example embodiments, the folding display may be a single flexible display. In some alternative example embodiments, the folding display may be two or more displays with the hinge being positioned between two displays.

Method 1000 and/or method 1100 can include presenting a first logical display portion on the first display portion of the folding display. Method 1000 and/or method 1100 can include presenting a second logical display portion on the second display portion of the folding display. Method 1000 and/or method 1100 can include determining whether the first housing portion is in angled position relative to the second housing portion (decision block 1025 and/or decision block 1125). In response to determining that the first housing portion is not in an angled position relative to the second housing portion, method 1000 and/or method 1100 ends after normal rendering of the notification/dialog for normal presentation on the logical display (at block 1050 and/or block 1152). The processor/controller then continues monitoring for the pivot sensor to indicate that the electronic device is configured with the first housing portion in the angled position relative to the second housing portion.

In response to determining that the first housing portion is in an angled position relative to the second housing portion (“Yes” at decision block 1025 and/or decision block 1125), in one or more embodiments, method 1000 and/or method 1100 can include triggering a front image capturing device positioned on an inward side of the first housing portion to activate and capture a preview image of a field of view of the front image capturing device (at block 1030 and/or block 1132). In one embodiment, method 1000 and/or method 1100 can include analyzing the captured preview image and determining whether a face of a user viewing the first display portion of the folding display is identified in the image (at block 1030 and/or block 1134). In one example, image recognition (e.g., via an AI module) identifies a human face that is positioned to be able to view the first display portion of the folding display. Likewise, method 1000 and/or method 1100 can include analyzing the captured preview image and determining whether a face of a user viewing the second display portion of the folding display is identified in the image (at block 1030 and/or block 1136). In one example, image recognition (e.g., via the AI module) identifies a human face that is positioned to be able to view the second display portion of the folding display. In some examples, method 1000 and/or method 1100 ends in response to determining that there is no face of a user identified viewing the first display portion of the folding display or the second display portion of the folding display.

Accordingly, aspects of the present disclosure provide enhancements with regard to the presentation and accessing of application notification and system dialogs on an electronic device having a foldable housing positioned in a partially folded angled position (i.e., sometimes also referred to as a “laptop” mode or “flex” mode herein). The system, components, and corresponding techniques described above with reference to the figures enable the management of notifications/dialogs on a foldable device while in the laptop/flex mode to ensure that the content of interest to the user is always made available to the current active device display portion, which is particularly advantageous in a split-screen use case as described herein. As such, the usefulness and convenience of the foldable electronic device is significantly improved while in the laptop/flex mode configuration.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.” While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
a foldable housing including at least a first housing portion and a second housing portion that are pivotable between a folded closed position and an unfolded open position, the foldable housing being configurable for angled positioning of the electronic device;
a foldable display including a first display portion positioned on an inward side of the first housing portion and a second display portion positioned on an inward side of the second housing portion;
at least one image capturing device positioned on the inward side of the first housing portion;
a memory having stored thereon a control module for controlling the at least one image capturing device and the foldable display; and
at least one processor communicatively coupled to the foldable display, the at least one image capturing device, and the memory, the at least one processor being operable to execute program code of the control module and configured to cause the electronic device to:
detect that the electronic device is placed in a first mode in which the first housing portion has an angled open position relative to the second housing portion;
determine whether a user is actively interfacing with the first display portion or the second display portion; and
in response to rendering at least one notification or dialog for presentation to the user while the electronic device is placed in the first mode, modify a selected one of the first display portion or the second display portion to present the at least one notification or dialog on the selected one of the first display portion or the second display portion with which the user is actively interfacing.

2. The electronic device of claim 1, further comprising:
at least one pivot sensor communicatively coupled to the at least one processor,
wherein the at least one processor is configured to cause the electronic device to:
detect that the electronic device is placed in the first mode in which the first housing portion has the angled position relative to the second housing portion based on input from the at least one pivot sensor.

3. The electronic device of claim 1, wherein to determine whether the user is actively interfacing with the first display portion or the second display portion, the at least one processor is configured to cause the electronic device to:
monitor a field of view of the at least one image capturing device;
determine a viewing angle of the user based on the field of view encompassing a face of the user; and
detect that the user has a gaze directed toward a specific one of the first display portion of the first housing portion or the second display portion of the second housing portion based at least in part on the viewing angle of the user.

4. The electronic device of claim 1, wherein to determine whether the user is actively interfacing with the first display portion or the second display portion, the at least one processor is configured to cause the electronic device to:
detect that the user is actively interacting with features presented on a specific one of the first display portion or the second display portion.

5. The electronic device of claim 1, wherein the foldable housing is configurable for angled positioning of the electronic device on a support surface with the second housing portion positioned on and aligned with the support surface and the first housing portion oriented away from the support surface in the first mode.

6. The electronic device of claim 5, wherein responsive to determining that the user is actively interfacing with the second display portion of the second housing portion, the at least one processor is configured to cause the electronic device to:
designate the second display portion as a primary viewing screen for the user; and
modify the second display portion to render the at least one notification or dialog for presentation only on the second display portion with which the user is actively interfacing and that is currently designated as the primary viewing screen for the user.

7. The electronic device of claim 6, wherein responsive to subsequently determining that the user is actively interfacing with the first display portion of the first housing portion, the at least one processor is configured to cause the electronic device to:
designate the first display portion as the primary viewing screen for the user; and
modify the second display portion and the first display portion to render the at least one notification or dialog for presentation only on the first display portion with which the user is actively interfacing and that is designated as the primary viewing screen for the user.

8. The electronic device of claim 1, wherein while the electronic device is placed in the first mode in which the first housing portion has an angled open position relative to the second housing portion, the at least one processor is configured to cause the electronic device to:
determine that the user has transitioned to actively interfacing with a different one of the first display portion of the first housing portion or the second display portion of the second housing portion; and
in response to rendering at least one subsequently received notification or dialog for presentation to the user while the electronic device is placed in the first mode, modify the different one of the first display portion or the second display portion to present the at least one subsequently received notification or dialog on the different one of the first display portion or the second display portion with which the user is actively interfacing.

9. The electronic device of claim 8, wherein to determine that the user has transitioned to actively interfacing with the different one of the first display portion or the second display portion, the at least one processor is configured to cause the electronic device to:
detect at least one of the user actively interacting with features presented on the different one of the first display portion or the second display portion or the user has a gaze directed toward the different one of the first display portion or the second display portion.

10. The electronic device of claim 1, wherein the electronic device is a foldable mobile device and the first mode is a laptop or flex mode of the foldable mobile device in which the first housing portion and the first display portion are positioned in a substantially vertical position with respect to the user and the second housing portion and the second display portion are positioned in a substantially horizontal position with respect to the user.

11. A method comprising:
monitoring a pivot position of a foldable housing of an electronic device, the foldable housing comprising a first housing portion and a second housing portion that are pivotable between a folded closed position and an unfolded open position, the first housing portion having a first display portion positioned on an inward side thereof and the second housing portion having a second display portion positioned on an inward side thereof, the foldable housing being configurable for angled positioning of the electronic device;
detecting that the electronic device is placed in a first mode in which the first housing portion has an angled open position relative to the second housing portion;
determining whether a user is actively interfacing with the first display portion or the second display portion; and
in response to rendering at least one notification or dialog for presentation to the user while the electronic device is placed in the first mode, modifying a selected one of the first display portion or the second display portion to present the at least one notification or dialog on the selected one of the first display portion or the second display portion with which the user is actively interfacing.

12. The method of claim 11, further comprising:
detecting, via at least one pivot sensor of the electronic device, that the electronic device is placed in the first mode in which the first housing portion has the angled position relative to the second housing portion.

13. The method of claim 11, wherein determining whether the user is actively interfacing with the first display portion or the second display portion comprises:
monitoring a field of view of at least one image capturing device of the electronic device;
determining a viewing angle of the user based on the field of view encompassing a face of the user; and
detecting that the user has a gaze directed toward a specific one of the first display portion of the first housing portion or the second display portion of the second housing portion based at least in part on the viewing angle of the user.

14. The method of claim 11, wherein determining whether the user is actively interfacing with the first display portion or the second display portion comprises:
detecting that the user is actively interacting with features presented on a specific one of the first display portion or the second display portion.

15. The method of claim 11, wherein responsive to determining that the user is actively interfacing with the second display portion of the second housing portion, the method further comprises:
designating the second display portion as a primary viewing screen for the user; and
modifying the second display portion to render the at least one notification or dialog for presentation only on the second display portion with which the user is actively interfacing and that is currently designated as the primary viewing screen for the user.

16. The method of claim 15, wherein responsive to subsequently determining that the user is actively interfacing with the first display portion of the first housing portion, the method further comprises:
designating the first display portion as the primary viewing screen for the user; and
modifying the second display portion and the first display portion to render the at least one notification or dialog for presentation only on the first display portion with which the user is actively interfacing and that is currently designated as the primary viewing screen for the user.

17. The method of claim 11, wherein while the electronic device is placed in the first mode in which the first housing portion has an angled position relative to the second housing portion, the method further comprises:
determining that the user has transitioned to actively interfacing with a different one of the first display portion of the first housing portion or the second display portion of the second housing portion; and
in response to rendering at least one subsequently received notification or dialog for presentation to the user while the electronic device is placed in the first mode, modifying the different one of the first display portion or the second display portion to present the at least one subsequently received notification or dialog on the different one of the first display portion or the second display portion with which the user is actively interfacing.

18. A computer program product comprising:
a non-transitory computer readable storage device having stored thereon program code which, when executed by at least one processor of an electronic device having a foldable housing including a first housing portion and a second housing portion, a foldable display including a first display portion positioned on an inward side of the first housing portion and a second display portion positioned on an inward side of the second housing portion, and at least one image capturing device positioned on the inward side of the first housing portion, enables the electronic device to perform operations of:
monitoring a pivot position of the foldable housing of the electronic device, wherein the first housing portion and the second housing portion are pivotable between a folded closed position and an unfolded open position, and the foldable housing is configurable for angled positioning of the electronic device;
detecting that the electronic device is placed in a first mode in which the first housing portion has an angled open position relative to the second housing portion;
determining whether a user is actively interfacing with the first display portion or the second display portion; and
in response to rendering at least one notification or dialog for presentation to the user while the electronic device is placed in the first mode, modifying a selected one of the first display portion or the second display portion to present the at least one notification or dialog on the selected one of the first display portion or the second display portion with which the user is actively interfacing.

19. The computer program product of claim 18, wherein responsive to determining that the user is actively interfacing with the second display portion of the second housing portion, the program code when executed by the at least one processor is configured to cause the electronic device to:
designate the second display portion as a primary viewing screen for the user; and
modify the second display portion to render the at least one notification or dialog for presentation only on the second display portion with which the user is actively interfacing and that is currently designated as the primary viewing screen for the user.

20. The computer program product of claim 18, wherein responsive to determining that the user is actively interfacing with the first display portion of the first housing portion, the program code when executed by the at least one processor is configured to cause the electronic device to:
designate the first display portion as the primary viewing screen for the user; and
modify the first display portion to render the at least one notification or dialog for presentation only on the first display portion with which the user is actively interfacing and that is designated as the primary viewing screen for the user.
